(19) United States
(12) Patent Application Publication
(10) Pub. No.: US 2002/0092525 A1
(43) Pub. Date: Jul. 18, 2002

(54) Method and sensor device for detecting gases or fumes in air

(76) Inventors: Hanns Rump, Hausen (DE); Olaf Kiesewetter, Geschwenda (DE); Rainer Klein, Mosbach-Neckarelz (DE); Carsten Supply, Dortmund (DE); Heinz-Walter Schockenbaum, Unna (DE); Wolfgang Voss, Iserlohn (DE); Jessica Gerhart, Hausen (DE)

Correspondence Address: HORST KASPER, 13 FOREST DRIVE, WARREN, NJ, 07059, US

(21) Appl. No.: 09/957,712

(22) Filed: Sep. 17, 2001

Related U.S. Application Data
(63) Continuation of application No. PCT/EP00/EP02371, filed on Mar. 17, 2000.

(30) Foreign Application Priority Data
Mar. 17, 1999 (DE) 199 11 867.1

(51) Int. Cl. A62B 7/00; A62B 9/00

(52) U.S. Cl. 128/205.23; 128/200.24; 128/204.17

(57) ABSTRACT

The Invention relates to method as well as a sensor device with a sensor element for detection of gases and vapors in air. The sensor element is preferably a heated metal oxide sensor with heating structure and gas sensitive layer, wherein the temperature of the gas sensitive layer can be maintained constant by way of a heating structure and an automatic control device. The sensor element is disposed in a heat in a preferably heat insulating casing for protecting against air flows, wherein the gas can penetrate into the casing through a gas permeable diffusion layer. The resistance of the heating structure, which is a measure for the temperature of the gas sensitive layer, is employed as a temperature reference for the automatic control according to the present Invention method. The temperature of the sensor element is purposefully influenced by adding further interference values to the automatic control value ‘sensor temperature’. The evaluation is performed by comparison the in each case actual sensor signal with a reference value, wherein the reference value is formed out of the weighted average signal of the sensor values and wherein the reference value adapts to the specific situation in each case.

### TECHNICAL FIELD

The invention relates to a method and to a sensor device for the detection of gases or vapors contained in air by way of an electrically heatable sensor element as well as a gas mask, wherein the method and sensor device are advantageously employed.

### STATE-OF-THE-ART

The following printed documents are known: DE 3613512; EP 0447619; EP GB 2266467; DE 4132680; EP 0410071; EP 0343521; WO 9612523 for the construction of gas sensor systems and in particular for the sensor technical surveillance of a breathing protective masks. The teaching provided by the state-of-the-art employs different sensor technologies:

1. Electrochemical cells: it is disadvantageous in the employment of electrochemical gas detection cells that these cells more or less selectively react to some gases. Therefore the application of these cells is subject to the precondition that essentially only a single gas has to be detected, which gas in addition has to be a known gas. In a practical situation it is evaluated as disadvantageous that this method is questionable based on this limitation in connection with several potentially dangerous gases (for example in the chemical industries). In addition to, the lifetime of electrochemical cells is limited. The cells are also very expensive.

2. Color change reactions, such as they are known from test tubes available commercially. The strong selectivity is a disadvantage of this sensor technology. This requires the precondition that the gases to be monitored are known. It is a further disadvantage that the chemical reactions employed for the color change detection are frequently not reversible, thus one-way sensors are present which have to be selected especially prior to each deployment and to which cannot be employed again in the following.

3. Metal oxide sensors according to the Taguchi principle: the advantage of the sensors includes that they react to all gaseous or vaporous substances in the air, which are oxidizable or reduceable. Depending on the composition of the gas sensitive layer, the electrical resistance is for example decreased by oxidizable substances. Reduceable substances increase the electrical resistance in this case. The disadvantage is that the sensors have to be heated, which uses up energy and which furnishes narrow limits to an operation of the sensor system with batteries. The substantial drift of the sensor value in standard air, for example when the air temperature changes and/or when the air humidity changes are a substantial disadvantage. Each Taguchi sensor exhibits an electrical semiconductor as a gas sensitive layer. All semiconductors change for example their resistance amongst others with the temperature. In addition, the reaction speed and the sensitivity of the sensor element changes relative to the intended gases such that the characterizing curves relative to the different gases can be substantially different from each other at different temperatures. For these reasons it is necessary to maintain the temperature of the gas sensitive semiconductor layer stable within narrow limits.

Even in case where the temperature of the heating structure could be maintained completely constant, this would nevertheless not reach a constant temperature of the gas sensitive layer under all circumstances, since the temperature gradient between the gas sensitive layer and the surrounding air is very large and since the temperature gradient is influenced by the emitted by the sensor element through radiation and convectively. The heat amount delivered by the sensor element to the ambient is on the one hand a function of the temperature gradient, on the other hand a function of the flow speed of the air relative to the sensor element.

Practically, one will always determine substantial variations of the sensor resistance despite expensive electronic automatic controls, which has limited in the past the deployment of semiconductor sensors substantially, because the base resistance of the gas sensitive layer massively varies with temperature.

It is known to evaluate sensor signals such that the actual signals of the sensor are compared with an average value of preceding sensor signals formed over a certain time period. This means the difference between the actual signal and the average value is evaluated. For example a switching signal can be released in case the amount of this difference surpasses a defined value.

If sudden events occur, to which the sensor responds, then these sudden events can be very well detected with this method. Slow and/or only small changes of the sensor resistance in contrast do not lead to any evaluations or, respectively, switching signals.

Slow changes of the actual sensor signal are ignored, where the slow changes can be caused either by a drifting behavior of the sensor itself or however by a change of the concentration of a vapor or gas addition in the ambient air.

In contrast reliably a switching signal is generated upon occurrences of sudden concentration increases of oxidizable gases in the ambient air.

In many cases it is however very important that also a slow rise of gas concentrations can be reliably detected. This is for example important in the monitoring of breathing protective masks, because for example the filter of the breathing protective mask typically does not suddenly lose its functioning upon a set duration of the filter, but the deposit power of the filter in most cases becomes creepingly worse. In addition the concentration of toxic gases can increase very slowly, which increase would have to be detected at any rate. The above illustrated method of the signal evaluation cannot be employed for this purpose without modification for the reasons recited.

The present state-of-the-art does not furnish a useful teaching as to how the Taguchi sensors can be employed in applications despite the apparent stability disadvantages of the Taguchi sensors, wherein the applications require safety with respect to erroneous alarms and the simultaneous capability of the detection of also small concentrations and/or small concentration changes.

Breathing protective masks are employed amongst others for protection against vaporous or gaseous and health endangering contaminations of the breathing air. In most cases protective masks are concerned, wherein the protective masks cover the complete face. The breathing air is filtered by exchangeable filter cartridges. The active charcoal of the filter cartridges is modified according to the requirements and is supplemented by additional dust filters. The sealing of the mask at the contour of the face is performed through flexible sealing lips and the mask. The separation of the feeding air (breathing in) and discharged air (breathing out) in general is performed with hinged valves, wherein the hinged valves separate the interior space of the mask in the guidance of the air into two regions, the mouth/nose space, which is formed by the internal half mask, and the eye space. The eye space is here free of discharged air and purposefully is flown through only by filtered fresh air, wherein the fresh air passes during breathing in from the eye space through hinged valves in the separation wall between the two regions into the mouth/nose space. Upon breathing out these valves are closed by the over pressure generated and the discharged air passes through additional valves to the outside.

Under the precondition of an orderly operating such protective mask can protect the carrier for a limited time against the health endangering effects of air contaminations. Depending on the concentration of the contaminants the filter cartridges however are exhausted after some time and decrease in their filtering effect. This decrease of the filtering effect however does not occur suddenly, but slowly rising depending on concentration. A corresponding situation holds for the contaminants concentration in the feeding air (breathing air). The filter/mask producers recommend in their instructions to change the filter ‘if a decrease of the filtering effect is determined through smelling or taste’. This method is, if it is not even despising the human being, at least extremely questionable, because in particular in case of a slow decrease of the filtering effect then the adaptation behavior of the smelling sense needs to the situation that health endangering contaminant concentrations within the mask can be perceived only very late. In addition some toxic gases such as for example carbon monoxide (CO) are free from smell and taste, such that these gases cannot be perceived, but can only be recognized first by way of their toxic effect on the human organism. This however can already lead to serious health damages or even to death. The sealing of the mask with the aid of the sealing lip at the face contour represents a further essential problem. In fact, various mask sizes are offered, nevertheless a reliable sealing is not always assured because of the different shapes of the faces. This is further rendered more difficult in case of carriers of beards.

Searches have given that no evaluable statistics exist relating to accidents, health damages, or death rates, which are associated with not properly functioning breathing protective masks. Based on the recited situation and the requirements of the professional associations and institutions relating to worker protection it can be assumed that the personal damage and the economic damage are very large, which damages are caused by the consequences of not properly functioning breathing protective masks.

Thus there exists the requirement of a monitoring system, which reliably indicates a penetration of contaminants into the feeding region of the breathing protective mask and which protects the user from health risks.

There are numerous proposals of a technical solution, which however in general are technically insufficient. At least up to now none of the proposed systems is available on the market, even though an urgent interest exists.

A solution is proposed in U.S. Pat. No. 4,873,970, where a warning device with an electrochemical cell is placed in a casing between the filter and the mask. A substantial disadvantage of this setup of a solution is the fact that only the toxic gases can be captured, which pass through the filter into the breathing air. Non-sealing of the mask, in particular at the critical sealing face between mask and contour of the face, cannot be recognized.

It is a disadvantage in connection with the deployment of electrochemical gas detection cells that these cells in general react selectively only to individual gases. The application of these cells therefore requires that essentially only a single gas has to be detected which in addition has to be known. It is evaluated as disadvantageous in a practical situation that this method is questionable based on this limitation in case of different potentially dangerous gases (for example in the chemical industries). Furthermore, the lifetime of electrochemical cells is limited. The cells are very expensive.

An analogous warning device similar to the warning device of U.S. Pat. No. 4,873,970 is indicated in the printed patent document EP 0447619. Essentially the task is the basis of the Invention of EP 0447619 to indicate the exhaustion state to the carrier of the device even in case of noise and bad viewability. This is provided according to the Invention of EP 0447619 in that the breathing resistance is noticeably increased upon exhaustion of the filter by a corresponding device and thus notice is given to the carrier of the device.

In addition to the disadvantages recited in connection with U.S. Pat. No. 4,873,970 there are in addition the disadvantages in printed patent document EP 0447619 that the carrier of the device loaded already with contaminants by the exhausted filter is further loaded in addition within increased resistance to breathing. The increase of the breathing resistance entails an additional risk which is to be avoided under any circumstances because also life-sustaining oxygen is received in a small amount by the increase in resistance in addition to the breaking through contaminants and because the carrier of the device has to pass under certain circumstances still a long distance in order to leave safely the contaminant loaded region or to exchange the filter.

A solution is indicated in the printed patent document EP 0535395 where a monitoring is performed both of the filter as well as a general non-sealing of the mask. This is accomplished by having placed a color change indicator on the internal half mask. This accomplishes that the complete inhaled air has to pass the sensor. A disk with a color change indicator is furnished as an indicator. However color change indicators are associated with the disadvantage that again it has to be known in advance which gas is to be detected. In addition nonreversible reactions are concerned, which exclude a multiple use. Corresponding considerations hold for the solution proposal presented in the printed patent document GB 22266467.

The solution proposals presented in the printed patent document EP 0343531 and WO 9612523 are also only in the position to indicate an exhausted filter. Non-sealing in the mask or in the sealing face toward the face of the person cannot be recognized.

### TECHNICAL PURPOSE

Therefore it is an object of the Invention to furnish a method and the sensor device for detection of gases or vapors contained in air, in particular in breathing air, with a high safety against erroneous alarm, wherein also small concentrations and/or small concentrations changes can be detected, as well as a breathing protective mask with a sensor microsystem, wherein most of the masks present commercially can be retrofitted with the protective breathing masks with sensor microsystem, wherein the most frequently present contaminants, for example vapors of organic solvents (VOC), carbon monoxide (CO), sulfur dioxide (SO2), ammonia (NH3) and further contaminants can be reliably detected with only an integrated sensor microsystem wherein also any said non-sealing of the mask is recognized in addition to the exhaustion of the filter, and wherein the sensor microsystem can be easily removed for the purpose of cleaning of the mask and can again be mounted.

### DISCLOSURE OF THE INVENTION AND ITS ADVANTAGES

The object of the invention is resolved according to the present invention by a method for operating sensor element for detecting gases or vapors contained in air, which sensor element exhibits a gas sensitive layer and is heatable electrically with a heating structure, characterized in that the temperature of the sensor element is controlled and the temperature set value is at least for a certain time changed depending on the size or the time behavior of the sensor signal with an imbalance value switched on.

A sensor device for detection of gases or vapors contained in air with a sensor element, wherein the sensor element exhibits a gas sensitive layer and wherein the sensor element is electrically heatable with a heating structure, for performing the method is characterized in that sensor element is disposed in a casing, wherein the casing shields the sensor element from air motions occurring outside of the casing, wherein the casing exhibits a diffusion layer through which a passage of gas and vapor from the outside into the interior of the casing and vice versa is possible based on diffusion.

The breathing protective mask according to the present invention with an easily removable sensor microsystem for the purpose of cleaning the mask comprises a sensor, an electronics with microprocessor and control/evaluation software and is characterized in that the microsystem informs the carrier or other persons about contaminants penetrating into the mask.

The method according to the present invention and the sensor system according to the present invention are very advantageously employable in a breathing protective mask according to the present invention. A breathing protective mask according to the present invention can very advantageously be operating with a method according to the present invention and with a sensor system according to the present invention.

Applications are amongst others in the protection of human beings, where the human beings employ the breathing protection equipment (for example breathing protection masks). A further application comprises the monitoring of air conditioning and ventilation plants with respect to an (undesired) presence of gases and vapors. Furthermore, the ventilation of motor vehicles can be controlled with the gas detectors according to the present invention such that the ventilation is interrupted in case gas concentrations are detected outside of the vehicle. Furthermore, the ventilation of the rooms or buildings as required can be performed with the gas detectors according to the present invention such that the ventilation rate is coupled to the concentration of for example organic air contents materials (gases, vapors). Furthermore, the monitoring of the air with respect to ignitable or, respectively explosion endangering gas air mixtures can be performed with the gas detectors according to the present invention.

The sensor of the sensor device indicated according to the present invention is a Taguchi sensor which exhibits and electrical semiconductor as a gas sensitive layer such as does every Taguchi sensor.

It is necessary for this purpose to maintain the temperature of the gas sensitive semiconductor layer stable within narrow limits. Already temperature automatic controls of sensors are known for this purpose, wherein some temperature automatic controls exploit the fact that the sensors exhibit heating structures made of platinum or another material with a pronounced temperature coefficient. Methods are known to a person of ordinary skill in the art how such heaters can be controlled such that the resistance of the heater is employed as an ACTUAL reference.

The sensor element exhibits a sensor substrate, a gas sensitive layer and a heater structure disposed between the sensor substrate and the gas sensitive layer. The heating structure is controlled electrically through an external resistor, wherein the external resistor is dimensioned such that the current flow in no case heats the sensor element to the set point temperature. Instead periodically an impulse is delivered to a switching device component through a control line from a central control and automatic control apparatus, advantageously formed as a microcontroller, wherein the switching device component delivers an energy rich switching pulse to the heating structure. The outer resistance and the heating structure form a voltage divider.

After switching off this power then that voltage is measured through a first analog/digital converter, which voltage is taken off at the voltage divider between the heating structure and the outer resistance.

If the voltage is too high, then the heating pulse for the number of heating pulses is shortened during the next periods. If in contrast the voltage should be too small, then the heating pulse or the number of heating pulses is lengthened during the next periods.

The impedance of the gas sensitive layer of the sensor element is measured with the central control and automatic control apparatus, suitable software and a second analog/digital converter, wherein the second analog/digital converter is connected to the gas sensitive layer and the impedance is thereby available as a signal for evaluation. Only the ohmic resistance is measured here in the most simple case.

Even if the temperature of the heating structure would be completely constant, nevertheless no temperature constant under any circumstances of the gas sensitive layer could be achieved because the temperature gradient between the gas sensitive layer and the surrounding air is very large and is influenced by the heat emitted by the sensor element by radiation and convectively. The thermal energy delivered by the sensor element to the ambient is on the one hand a function of the temperature gradient, on the other hand a function of the flow speed of the air relative to the sensor element.

Therefore one will find in practical situations always substantial variations of the sensor resistance in standard air despite expensive electronic automatic controls, which fact has restricted substantially the employment of semiconductor sensors in the past since the base resistance of the gas entity for layer massively varies with the temperature.

A sensor device according to the present invention therefore exhibits a sensor element which is disposed in a casing, which is air technically closed and which does not allow air motions outside of the casing any access to the heated sensor element. The casing is advantageously constructed such that its internal space is thermally insulated relative to the surroundings.

After some time a thermal balance between the heating structure, the sensor substrate as the heat storage, and the gas sensitive layer is formed in the casing, since also the air is heated to a higher level in the surroundings of the heat structure, the sensor substrate, and the gas sensitive layer and thereby the temperature gradient between air and sensor element is decreased. The undesired variations of the sensor resistance caused by the temperature gradient between air and sensor element are essentially reduced in this manner according to the present invention.

According to the present invention the casing exhibits a semi permeable diffusion layer, which diffusion layer is practically impermeable for air flows, which diffusion layer however can be penetrated by diffusing air and gas particles. According to the present invention thus based on the different partial pressures inside and outside of the casing, gases diffuse into the casing or out of the casing through the diffusion layer, wherein however an air circulation through the diffusion layer is practically suppressed. Induced heat streams based on air motions through the semi permeable diffusion layer are therefore excluded or at least very strongly limited.

The casing including the diffusion layer is formed heat insulating and/or thermally insulating according to a preferred embodiment of a sensor device according to the present invention.

This in combination with very precise heating automatic control accomplishes that no effects of the ambient temperature show up any longer on the sensor resistor in standard air over a very wide temperature region.

It is a further advantage that the energy requirements of the sensor element can be substantially decreased by the heat insulating and/or thermally insulating formation of the casing and of the diffusion layer according to the present invention, which is very important and advantageous in connection with operating with batteries.

As already recited above in connection with the illustration of the state-of-the-art, it is known to evaluate the difference between the actual signal and an average value. If events occur suddenly, to which events the sensor responds, then these events can be very good detected according to this method. Slow and/or only small changes of the sensor resistance lead in contrast to known evaluations or, respectively, switching signals. The actual sensor signal is average over a predetermined time period and is headed with a constant value such that an average signal results disposed on average slightly above the sensor signal which is employed as a reference signal 52.

If events occur which change the value of the actual sensor signal to values above the reference signal, then a switching signal is released. Slow changes of the actual sensor signal are ignored. In contrast to that a switching signal is reliably generated upon occurrence of sudden concentration increases of oxidizable gases in the ambient air.

However it is very important in many cases that also a slow rise of the gas concentration is reliably detected, for example in case the concentration of toxic gases increases very slowly, which must be detected at any rate. The illustrated method cannot be employed in this case without modification.

The heating power is influenced by an additional value (to the temperature) according to an invention method for operating a sensor device. An interference value switch on is performed thereby as considered by automatic control technology.

The observation that changes of the electrical parameters of the gas sensitive layer of the sensor element (resistor, capacitance, inductivity) as well as derived of the offering of oxidizable gases or reduceable gases as well as a result of very issuance of the air humidity or of the temperature are the basis of the idea of the present invention.

For purposes of simplicity only the detection of oxidizable gases is described in the following. Reduceable gases behave principally inversely, that is reduceable gases increase also for example the sensor resistance, whereas oxidizable gases reduce the sensor resistance. The invention is applicable sensibly even though also inversely, also for reduceable gases.

A method according to the present invention is illustrated in the following. At the start, the sensor in standard air delivers an actual sensor signal at a determined heating power. In the following the sensor is impacted by a gas pulse of a predetermined time duration.

In case of a not influenced heating power the actual sensor signal returns only after a longer time period to the starting value after the end of the gas pulse. A heating power with interference value switch on in contrast leads to an actual sensor signal influenced by the heating power, which actual sensor signal returns quicker to the starting value. If the heating power is always then led after for example proportional in the sense of a temperature increase in case the actual sensor signal passes through a change, then the actual sensor signal returns significantly faster to the starting value.

It is essential that the reactions of the gas sensitive layer with the gas occur at any rate in the case of an actually present gas concentration at the sensor. The temperature sensitivity of the sensor signal is reduced by the effects and interactions of the gases. The change of the sensor signal effected by the temperature follow-up therefore is smaller during the gas impulse as compared to prior or after the gas impulse. In other words: the sensor signal reacts during the gas impulse only relatively weak to a change in the heating power and thus to the interference value switch on. The gas induced reduction of the actual sensor signal therefore assumes approximately the same course as is present in case of an otherwise identical arrangement without temperature follow-up upon leading after and following on to the heating power.

If however the reaction of the actual sensor signal is for example caused by a change of the air humidity or by a change of the air temperature, then the temperature sensitivity of the sensor signal does not change or changes only very little. A change of the air humidity or a change of the air temperature therefore have substantial and continuing influence on the actual sensor signal in case of a not influenced heat power.

The influence of the sensor signal effected by the temperature tracking is clearly larger than in the case of a gas pulse where however already at the start of such an interaction the heating power was tracked. The monitoring of the lower explosion boundary for protection against accidents after gas linkages is also sensible. In other words: the sensor signal reacts heavily to a change of the heating power and thus to the interference value switch on. The change of the sensor value caused by a change in the air humidity or on a change of the air temperature is therefore not only much smaller, but also timewise clearly shorter than in the case of a not influenced heating power.

Therefore the heating automatic control of the sensor is constructed such according to the present invention that the guiding value of the heating automatic control is the temperature and that an interference value is switched onto the automatic control values, wherein the interfering value is derived from the deviation of the actual sensor signal relative to a standard value in case of standard air.

Both the signal processing as well as the heating automatic control can advantageously be controlled by a single single-circuit controller (uC).

A combination of

a. an arrangement of the sensor element in a preferably thermally insulated or, respectively, heat insulating casing with the thermally insulating or, respectively, heat insulating diffusion layer through which a gas access to the sensor element can be performed by diffusion without air motion,

b. a diffusion caused gas access to the sensor without air motion, operating time of the system according to an embodiment of the invention.

The first comparison value is obtained from the average value over a relatively short time period, since the system is subject to necessarily high self dynamic variations immediately after the switch on. This time period is increased after the switch on phase and this time period finally reaches a substantially longer integration time in the built-up state. A certain amount is deducted from the calculated average value in order to form the so-called reference value, since the average value in principle can coincide with the actual sensor signal.

According to a preferred variation of an embodiment the amount to be deducted is very large during the initial phase such that the reference value gets a large distance relative to the sensor value. This is important in order to prevent that signals are released in the non-built-up state, even though no significant gas concentration change occurs. The amount is successively decreased in the further course of time such that the reference value approaches more and more the sensor value in the built-up state.

Further refinements can be introduced. According to a further variation of an embodiment of the invention method the reference value is brought again to a larger distance relative to the sensor value after violent gas induce sensor reactions, since violent reactions of the sensor lead to temporary instable sensor situations.

According to a further embodiment variation of the invention method the calculation of the average value is again performed over shorter time periods, when a gas induced strong sensor signal change has occurred. According to a further variation of an embodiment the calculation of the average value is dispensed with for that time period during which time period a gas induced sensor signal change occurs.

Despite the recited steps the actual gas level can rise in such a slow extent that the average value follows essentially to this rise. In this case slowly substantial gas concentrations can be formed without that the precedingly described release condition would be fulfilled according to which the actual

c. a heating of the sensor element by automatic control of the temperature, wherein the relative deviation of the actual sensor resistance from the resistance of the sensor element under standard conditions is switched on to the automatic control circuit as an interference value,

comprises the advantageous result that the sensor signal follows quickly and nearly exclusively to the factual contents of oxidizable air contents substances and further exhibits by far less drifting features as hitherto known.

If an evaluation is performed which compares the actual sensor value with an average value determined over the time, then substantially less variations of the sensor signal under standard conditions can be assumed, in particular then, when the system has become stable after some time.

Therefore the time period over which the average value of the actual sensor signal is formed for solving as a comparison value relative to the actual sensor value is not constant but increases always in the course of the sensor signal assumes a smaller value as compared with the reference value determined by calculation.

According to a further variation of embodiment therefore additionally a minimum value is fixed for the reference value, wherein the actual reference value never can become smaller than its fixed minimum value. The minimum value is selected such that this limit is not reached by sensor caused variations, and on the other hand the gas concentrations, which can be coordinated to this sensor signal, do not yet inflict permanent damages to the human being, or, respectively, in the case of for example of a monitoring of explosive limits (for example methane air mixtures) and are disposed at a far safety distance relative to the explosion limit.

If jump like changes of the humidity or temperature occur (for example upon application of the sensor at a suitable position in or at breathing protective masks for the purpose of the filtering or sealing monitoring) then the effect of these influences on the sensor resistance upon application of a method according to the present invention will be absolutely smaller and only occur temporarily.

Nevertheless an erroneous signal triggering can occur, which then would be an undesired erroneous alarm. According to a further variation of embodiment therefore a time staggered evaluation is performed, which time staggered evaluation is illustrated in the following.

A reference value is disposed below the sensor standard level. If a gas impulse decreases the actual sensor signal by a certain amount, then the reference value is undershot and thereby the switching criterion is fulfilled. Thereby a kind of ‘quiet pre-alarm’ is released, however according to the present invention the switching signal is not yet triggered. A switching signal is released only then when the switching criterion remains fulfilled for a certain time period, which switching signal is maintained present during the remaining time period, during which time the actual sensor signal remains below the reference value.

If in contrast a very short term and therefore practically to be neglected gas impulse occurs or if a humidity impulse to be compensated according to a method of the present invention occurs, wherein the humidity impulse triggers about a reaction of the actual sensor signal, then according to the present invention no switching signal is triggered.

According to a further variation of embodiment of the invention method, the time period of the pre-alarm is not fixedly defined, but instead of function of the quickness of the sensor signal change or as a function of the absolute change amount over the time period. If thus a very large sensor signal change has occurred during a fixed time period, then the time period of the prealarm can be shortened. This is advantageous in order to be able to maintain the time up to the triggering of the alarm as short as possible in case of an actually suddenly occurring large gas concentrations.

A similar result can be obtained if the sensor signal is average over two different time periods, for example both over time period of 20 seconds as well as over time period of 300 seconds. As previously recited a certain amount of for example 2 percent of the standard value or the like is deducted from the average value formed over the longer time period. The values determined in this way are compared with each other.

If the average value formed over the shorter time becomes smaller as compared to the average value formed by averaging over the longer time period and the value resulting after deduction of a certain amount (for example 2 percent) then a switching signal is triggered.

Frequently however it is not sensible to deduct only a constant amount from the average value for forming a reference value, since the sensor characteristic curve (sensor signal depending on the gas concentration) is usually a nonlinear curve.

In the case that the ohmic resistance of the gas sensitive layer is employed for forming the actual sensor signal, then this means that for example 10 ppm (parts per million) of a certain gas effect different resistance changes depending on the base resistance of the gas sensitive layer. Thus the relative resistance change caused by 10 ppm offered gas is substantially smaller for example in case of a low base resistance as compared with the situation at a high base resistance. This fact can be taken into concentration by taking into consideration the sensor characteristic curves of different object gases in the calculation of the reference value based on the determined average value according to the present invention.

The employment of the described sensor system is in particular critical when the system is taking into operation while already a substantial load of gas is present. Since the system is in fact incapable of measuring absolute concentrations but can only capture changes (relative to a reference value) within the time period of observation, then the system would not deliver any suggestion (switching signal, alarm) relative to the infect present loading with gas.

This problem situation is resolved according to the present invention by increasing for short time period the temperature of the gas sensitive layer according to a further variation of deployment of the invention method. The temperature increase effects on the one hand a shifting of the reaction balance within the gas sensitive layer, wherein the shifting becomes apparent via change of the sensor signal, and on the other hand the sensor is operated for short time at a different (temperature dependent) characteristic curve. The capturing and the evaluation of the sensor signal prior to, during, and after the short term temperature increase allows concludes relative to a possibly present gas load.

A breathing protective mask according to the present invention is illustrated in the following.

Various, alternatively employable solutions are provided for the gas technical connection of sensor and intern space of the mask according to the present invention:

1. The sensor system is gas tight attached at the mask a collar piece integrated into the outer skin of the mask. The attachment is performed according to the present invention such that the sensor gas technically is in connection with the eye chamber of the mask. The eye chamber is free from the exhaled breathing air of the carrier of the mask caused by the valve controlled guidance of the air in the mask and the eye chamber contains only the part of the air which is breathed in. The attachment of the collar piece is performed advantageously through a gas tight screw thread connection or a gas tight bayonet catch, such that the sensor system can be easily and without special tool removed for the purpose of mask cleaning or in case of nonuse. The collar piece is gas tight closed with a blind plate for further application of the breathing protective mask in case of a nonuse of the sensor system.

2. In most cases the breathing protective masks are furnished with a view disk made of a clear transparent plastic, wherein the view disk covers the largest part of the face. The viewing disk can be modified such that the sensor system can be attached there in most cases without substantial interference with the field of view at the lower edge of the viewing disk. The sensor is gas technically connected here with the eye chamber of the mask through an opening sealing relative to the outside. The attachment of the sensor system (sensor plus electronic) is performed here also through gas tight windings, a gas tight bayonet closure or other gas tight attachments easily to be disengaged without tool and known to a person of ordinary skill in the art. The optical functioning and warning devices (for example of light emitting diode LED) connected to the sensor system can be reliably perceived since the optical functioning and warning systems are disposed directly in the field of view. It is advantageous in connection with this variation that upon retrofitting of a present protective mask, only the view disk has to be exchanged.

3. The sensor system can be carried also disengaged from the protective mask, for example at the closure belts of the breathing protective mask at the rear head or at the belt of the carrier of the device in those cases where an attachment at the viewing disk or at the lower acts of the breathing protective mask is not possible or is not sensible. Advantageously, the gas technical connection between eye chamber and sensor is performed for example through a flexible hose connection, which is gas tight toward the outside. The gas transport from the eye chamber to the sensor can be performed by diffusion. This is however associated with the disadvantage of a possibly substantial time delay between the occurrence of a contaminant in the eye chamber and the detection by the sensor system. It is therefore additionally proposed in accordance with the present invention that the gas transport between the eye space and the sensor is performed through an electrically operated small fan or with the aid of a membrane pump, wherein the membrane pump is driven by the pressure differences occurring during the natural breathing. Such a membrane pump driven by the pressure differences can be easily indicated by a person of ordinary skill in the art. The air transported to the sensor is either delivered to the outside air through a hinged valve or is returned to the eye chamber through a further hose connection.

4. The sensor system can be placed alternatively also in an adapter disposed between filter and mask. It is to be considered in this context that the hinged valve disposed usually between filter and mask side of the connection thread in the mask is integrated into the adapter on the filter side. This is necessarily required because otherwise no leaks of the mask itself can be recognized. The gas transport from the eye chamber to the sensor through diffusion is assured by this step without that the otherwise functioning of the mask is interfered with.

The signaling of contaminants penetrating into the mask is performed optically, for example through light sources and preferably different colored light emitting diodes LED according to the present invention. An alarm can be performed alternatively or in addition also acoustically, for example with the aid of sound converters. The employment of irritating currents or stimulating currents is proposed for situations where the acoustic or optical capability of perception of the carrier of the device is limited, wherein the irritating currents for stimulating currents are medically harmless, but nevertheless reliably signal an alarm.

Since the sensor microsystem amongst others comprises an integrated microprocessor and other electronic components, it is conceivable that the system is such interfered with by way of strong electromagnetic radiation or other perturbing influences that an orderly functioning is not any longer assured. Therefore the essential parameters of the system for the functioning are monitored in accordance with the present invention. In case of a proper functioning this is indicated by a changing optical display, for example preferably a blinking, color light emitting diode LED. The control of the optical display is performed here directly by the integrated microprocessor. This is associated with the advantage that by way of the blinking of the display there is also monitored the processor itself.

Situations are also conceivable in which an alarm signal to the carrier of the apparatus by itself is not sufficient. This is for example possible in case of suddenly occurring high contaminant concentrations in the breathing air, which high contaminant concentrations render the carrier of the apparatus incapable of operating. This situation can for example occur where the breathing protective mask is unintentionally removed from the face in an environment with high contaminant concentration. It is proposed according to the present invention for these cases that the data of the sensor microsystem (proper functioning, gas concentration in the breathing air, alarm signal) are transferred to a central office through a wireless data remote connection, for example a digital coded radio connection. The signals of individual systems can be differently digitally coded for distinction in case of a remote monitoring of a plurality of mask carriers with sensor systems.

Frequently it is required to reconstruct afterwards possibly occurred contaminant loads of the carrier of the device, for example in case of work accidents it is proposed for these or other cases according to the present invention to store the relevant sensor data (for example for proper function, gas concentration in the breathing air, alarm signal) during the operational time of the sensor system in a digital storage (comparable with the black box of commercial airliners). These could then afterwards be evaluated if required.

It is provided according to the present invention for a further variation of embodiment of the breathing protective mask with sensor microsystem to switch over to a second filter in case of a high contaminant concentration in the breathing air of the carrier of the device. This however is only sensible where the increased contaminant concentration is caused by an exhausted filter. It is provided according to the invention to automatically open a valve, which ventilates the internal mask with air or with pure oxygen in cases where side and leak of the mask occurs for additional safety. The increased pressure drives the charged air to the outside and enables the carrier of the device to leave the loaded region or to take other protective steps. The air or the pure oxygen is derived from a suitable pressure container, which pressure container is attached on the outside at the mask.

It is additionally furnished as a safety increasing feature to furnish the mask with an additional sensor, which additional sensor monitors the air quality also outside of the mask. Upon presence of a pre-driven contaminant concentration in the outside air a so-called prealarm can be signaled, wherein the prealarm requests increased attention and care from the mask carrier.

The sensor system preferably to be employed for the detection of the contaminants penetrating into the mask is a microsystem comprising out of the components metal oxide sensor, electronic and microprocessor with integrated software for controlling and evaluating the sensor element. The breathing protective mask according to the present invention can be equipped particularly advantageously with a sensor device according to the present invention for detection of gases or vapors contained in the air and can be particularly advantageously operated according to a method of the present invention for detection of gases or vapors contained in air.

Short description of the drawing, where there is shown:

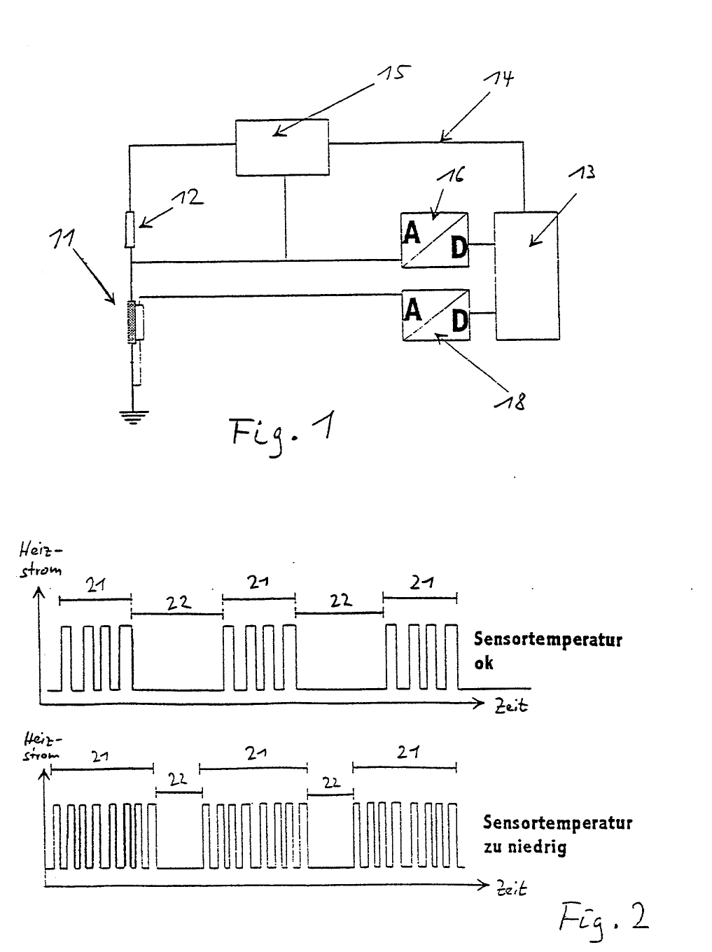

FIG. 1 a schematic representation of a sensor element with a typical known circuit, which is employed in a preferred embodiment of the invention,

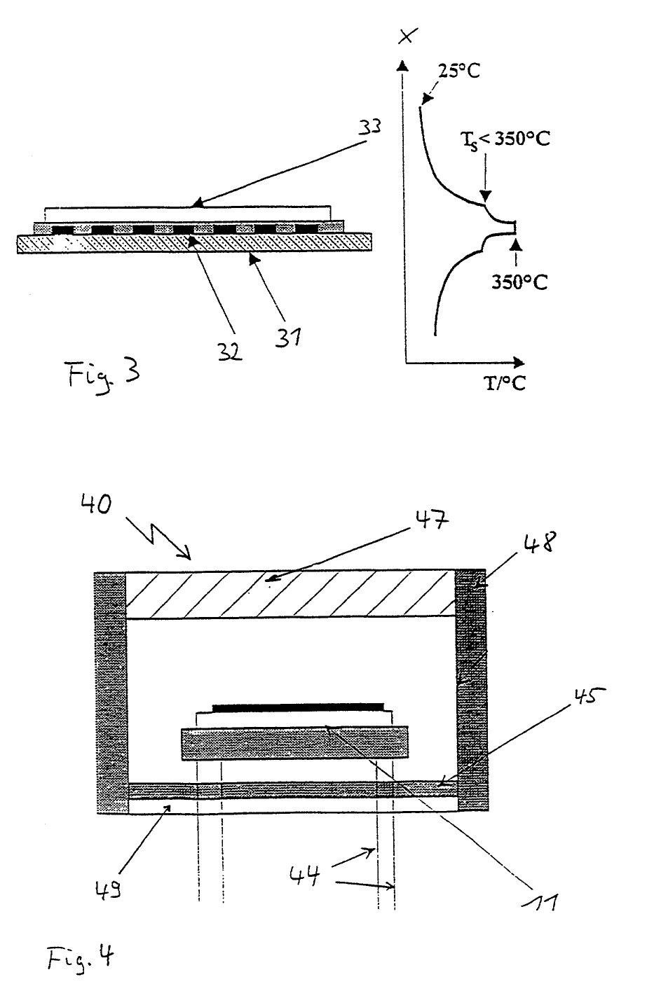

FIG. 2 a schematic representation of a time sequence of a plurality of heating impulses and of time intervals without current for temperature automatic control,

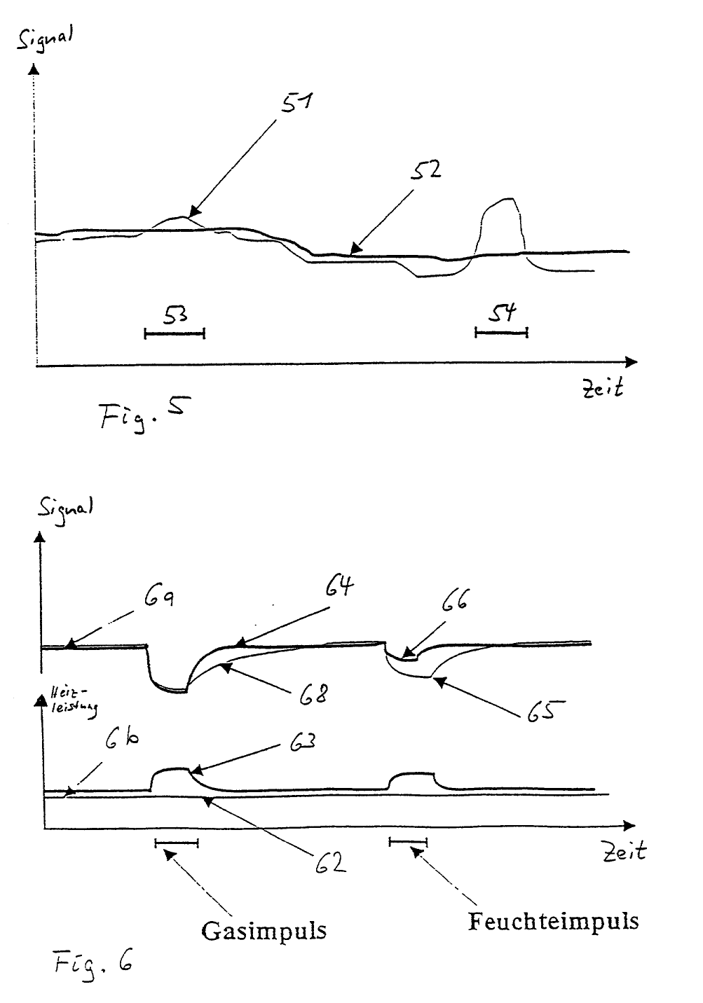

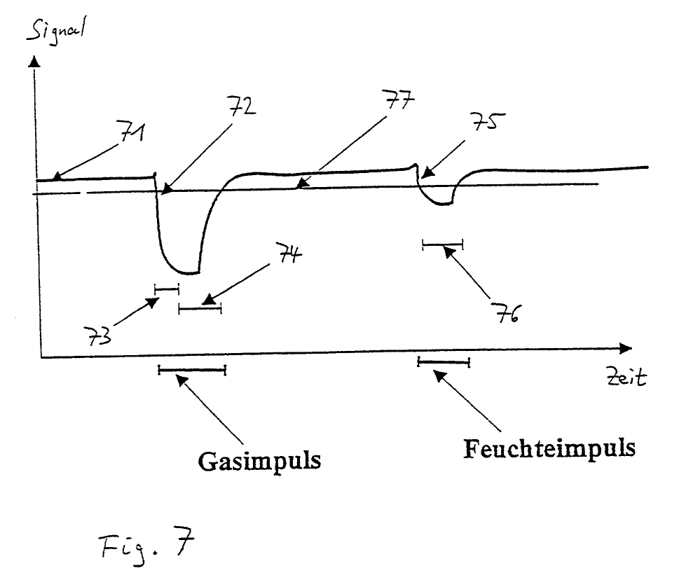

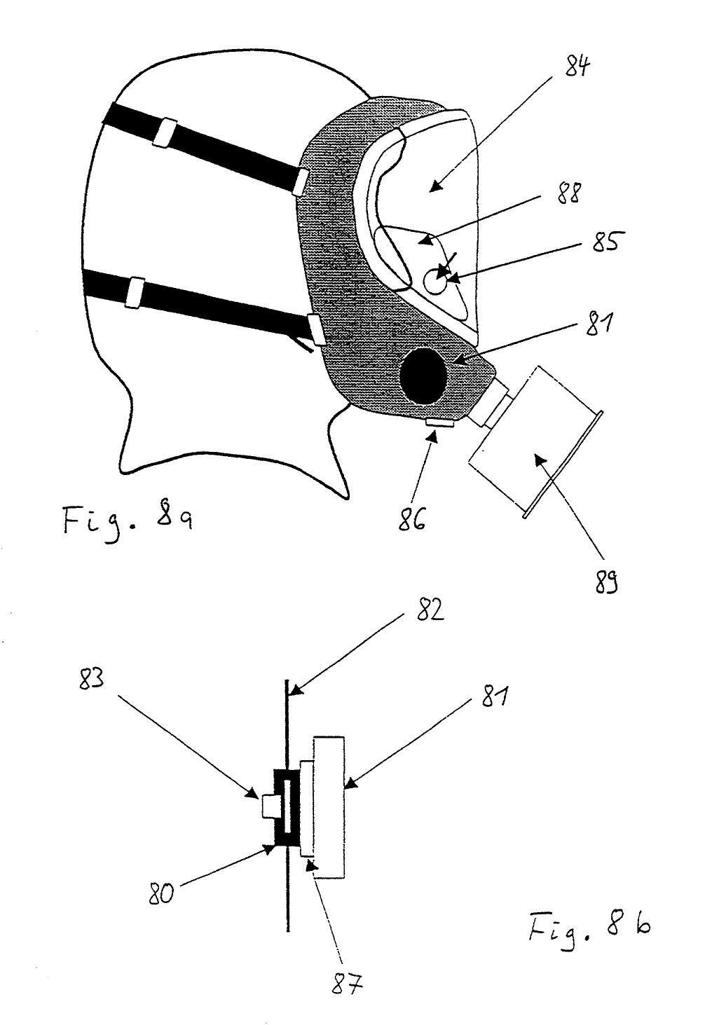

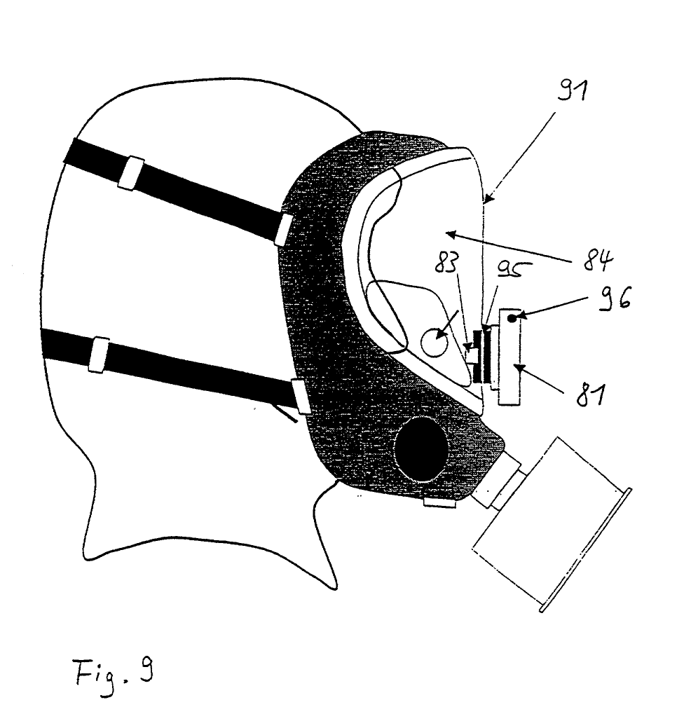

FIG. 3 a detailed presentation of the sensor element (left) as well as the typical course of the temperature in the direction perpendicular to the plane of the sensor element (right),

FIG. 4 an arrangement according to the present invention of a sensor element in a casing,

FIG. 5 an example showing the time course of the sensor signal and of the heating power according to a method for operating the sensor element corresponding to the state-of-the-art,

FIG. 6 an example for the time course of sensor signal and heating power according to a variation of an embodiment of the invention method for operating the sensor element,

FIG. 7 an example for the time course of sensor signal and heating power according to another variation of an embodiment of a method according to the present invention for operating of a sensor element,

FIG. 8 an embodiment of the breathing protective mask according to the present invention,

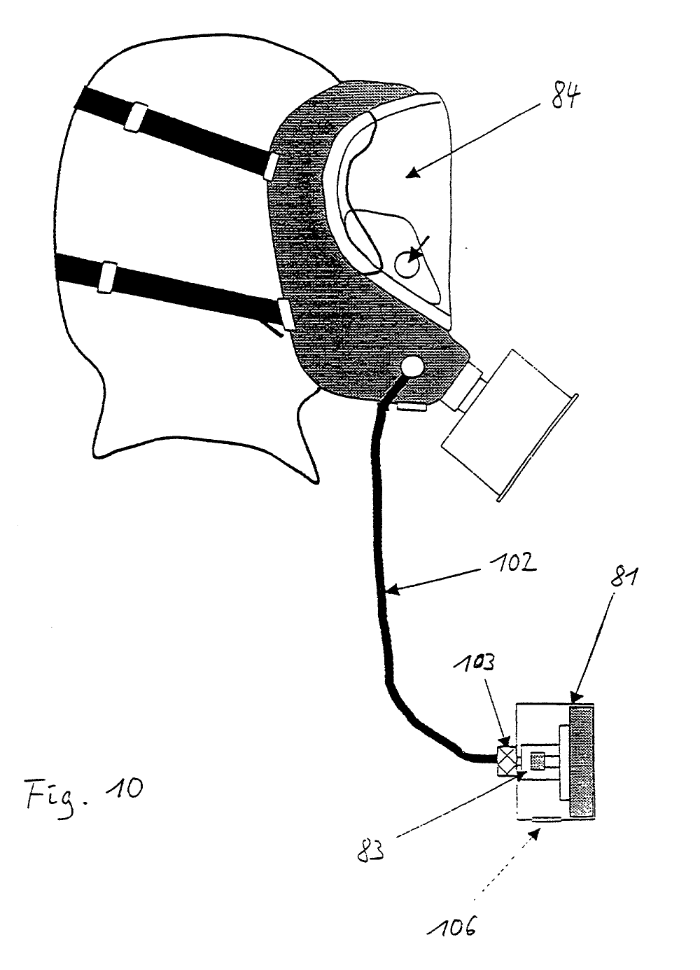

FIG. 9 another embodiment of a breathing protective mask according to the present invention,

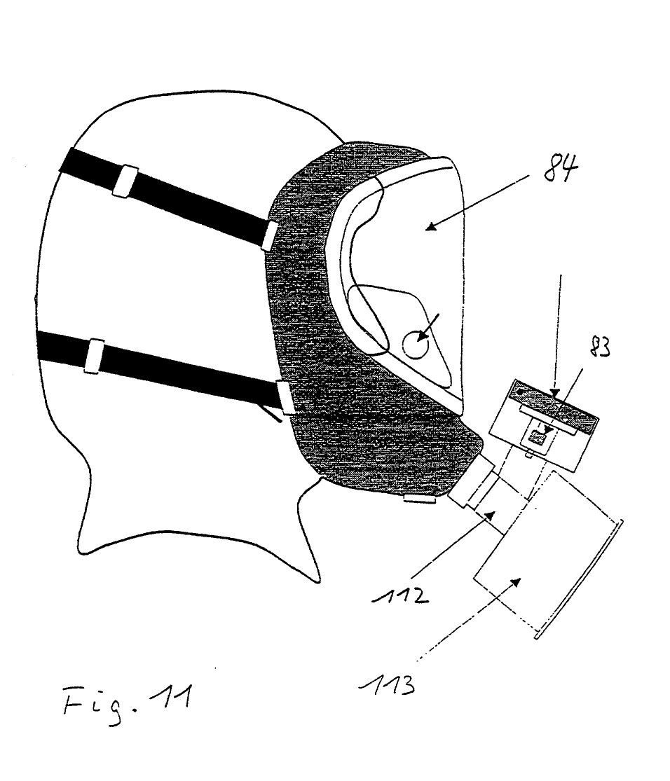

FIG. 10 a further embodiment of a breathing protective mask according to present invention,

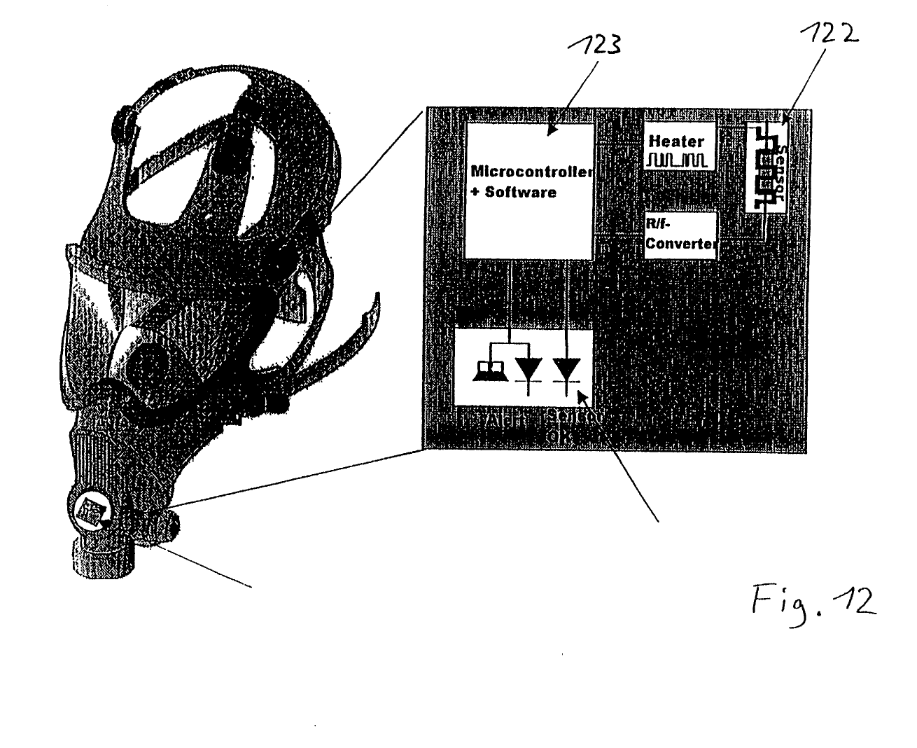

FIG. 11 a further embodiment of a breathing protective mask according to the present invention, and

FIG. 12 a further embodiment of the breathing protective mask according to the present invention.

FIG. 1 shows schematically a sensor element 11 with a typical known circuit, which circuit is employed according to a preferred embodiment of the invention. The sensor element 11 exhibits a sensor substrate 31, at gas sensitive layer 33 and the heating structure 32 disposed between the sensor substrate 31 and the gas sensitive layer 33 (FIG. 3). The heating structure 32 is controlled electrically through an outer resistance 12 (FIG. 1), wherein the outer resistance is dimensioned such that the current flow and no circumstances will heat the sensor element 11 set point temperature. Instead of, impulse is delivered periodically to a switching component device 15 from a central control and automatic control device 13, advantageously formed as a microcontroller (uC), wherein the switching component device 15 delivers an energy rates switching impulse to the heating structure 32. The outer resistance 12 and heating structure 32 form a voltage divider.

After turning off this impulse the voltage is measured over a first analog/digital converter 16, which voltage is tapped at the voltage divider between the heating structure 32 and the outer resistor 12.

If the voltage is too high (heating structure 32 has an ohmic value to ride, therefore the sensor temperature is too high) then during the next period the heating impulse or the number of heating impulses is shortened. If in contrast the voltage would be too small (heating structure 32 is too low ohmic, therefore the sensor temperature is too low), then the heating impulse or the number of heating impulses is lengthened during the next periods.

The impedance of the gas sensitive layer 33 of the sensor element 11 is measured with the central control and automatic control device 13, suitable software and a second analog/digital converter 18, wherein the second analog/digital converter 18 is connected to the gas sensitive layer 33, and the impedance thereby stands available as a signal for evaluation purposes. In the most simple case only the ohmic resistance is hereby measured.

FIG. 2 shows the time sequence of a plurality of heating impulses 21 and of time intervals 22 without current for illustrating the systematic of the temperature automatic control. If the temperature corresponds to the set point value, then a certain relationship exists between the number of heating impulses 21 and the time intervals 22 (FIG. 2 top) without current. If the sensor element 11 for example is cold, then the number of heating impulses 21 is increased and the time intervals 22 without current are shortened relatively (FIG. 2 bottom).

FIG. 3 shows the detailed representation of the sensor element 11 (left) as well as a typical course of the temperature in one direction ( ) designated in FIG. 3 as x-direction) perpendicular to the plane of the sensor element 11 (right) and renders visible the principal difficulty of the temperature automatic control. The heating structure 32 is disposed between the gas sensitive layer 33 and a sensor substrate 31. Even if the temperature of the heating structure 32 would be constant completely, then nevertheless therewith no constant temperature under all circumstances of the gas sensitive layer 33 can be accomplished, since the temperature gradient between the gas sensitive layer 33 and the surrounding air is very large and is influenced by the heat delivered by the sensor element 11 based on radiation and convectively.

If for example the temperature of the heating structure 32 is dramatically controlled to 350 degrees centigrade, then the temperature in the ambient air can vary in practical situations between minus 40 degrees centigrade and plus 80 degrees centigrade. A temperature deviating from the heater can be determined at the surface of the gas sensitive layer 33 based on the temperature gradient between the surroundings and the sensor element 11, wherein the deviating temperature is typically smaller as compared with the set point value.

The thermal energy delivered by the sensor element 11 to the surroundings is on the one hand a function of the temperature gradient and on the other hand a function of the flows speed of the air relative to the sensor element 11.

Even in case of only the smallest air motions in the neighborhood of the sensor element 11, the temperature gradient changes between

the heating structure 32 maintained at a constant temperature,

the gas sensitive layer 33 and the

temperature of the surrounding air.

Therefore one will be determining practically always substantial variations of the sensor resistance in standard air despite expensive electronic automatic controls, which situation in the past has substantially limited the deployment of semiconductor sensors, since the base resistance of the gas sensitive layer 33 massively varies with the temperature.

FIG. 4 shows a sensor device according to the present invention. A sensor element 11 is disposed in a casing 40, which casing 40 is air technically closed and does not allow access to the heated sensor element 11 for air motions outside of the casing 40. The casing 40 is preferably constructed such that the inner space of the casing 40 is insulated thermally relative to the surroundings.

After some time of thermal balance between the heating structure 32, the sensor substrate 31 as a thermal storage and the gas sensitive layer 33 is formed in the casing 40, because also the air disposed in the surroundings of the gas sensitive layer 33 is heated to a higher level and the temperature gradient between air and sensor element 11 is thereby decreased. The undesirable variations of the sensor resistance caused by the temperature gradient between air and the sensor element 1 are in this fashion substantially reduced according to the present invention.

The casing 40 shows according to the present invention a semi-permeable diffusion layer 47, which diffusion layer 47 is practically in permeable for air flows, however can be penetrated by diffusing air particles and gas particles. The diffusion layer 47 comprises for example finest capillary plastic (Teflon, stretched foils and the like) or for example a sinter body out of metal, plastic, glass or ceramics. The diffusion layer forms the cover face of the casing 40 according to a preferred embodiment of the invention. Gases diffuse through the diffusion layer 47 into the casing 40 or out of the casing 40 based on the different particle pressures inside and outside of the casing 40 according to the present invention wherein however an air circulation through the diffusion layer 47 is practically suppressed.

Thermal currents induced based on air motions through the semi-permeable diffusion layer 47 are excluded or at least very strongly limited.

The connection wires 40 for the sensor element 11 are preferably sealing against gas and are led through the casing floor 45. Preferably this is performed by melting the connection wires 44 into a glass layer 49 covering the casing floor 45.

According to a preferred embodiment of a sensor device according to the present invention the casing jacket 48, the casing floor 45 as well as the diffusion layer 47 and thereby the casing 40 are constructed heat insulating and/or thermally insulating.

It is accomplished hereby in combination with a very precise heating automatic control that no effects of the ambient temperature onto the sensor resistance in standard air show up any longer over very wide temperature range.

It is a further advantage that the energy requirement of the sensor element 11 can be substantially decreased by the heat insulating and/or thermally insulating construction of the casing 40 and of the diffusion layer 47, which is very important and advantageous during operation with batteries.

It is known to evaluate the difference between an actual signal and the average value as was already recited above in connection with the illustration of the state-of-the-art. If suddenly events occur to which the sensor responds then these sudden events can be very good detected with this method. Slow and/or small changes of the sensor resistance in contrast lead to no evaluations or, respectively, switching signals.

FIG. 5 illustrates this known method. The actual sensor signal 51 is averaged over assert time period and added to a constant value such that an averaged signal results disposed on average slightly above the sensor signal, which is referred to as reference signal 52. If events 53,54 occur, which change the value of the actual sensor signal to values above the reference signal 52, then a switching signal is triggered.

Slows changes of the actual sensor signal are ignored. In contrast a switching signal is reliably generated upon occurrence of sudden concentration increases of oxidizable gases in the surrounding air.

In many cases it is however very important that also a slow rise of gas concentrations is reliably detected, for example in cases where the concentration of toxic gases slowly increases, which has to be detected at any rate. The method illustrated with reference to FIG. 5 can therefore not be applied without modification.

The heating power is influenced by an additional value (relative to the temperature) according to the present invention method for operating of a sensor device according to the present invention. An interference value switch on is performed from a automatic control technology point of view.

The observation that changes of the electrical parameters of the gas sensitive layer 33 of the sensor element 11 (resistance, capacitance, inductivity) can be derived both from the offer of oxidizable or reduceable gases as well as can be the result of variations of the air humidity or of the temperature is a basis of the invention idea.

Only the detection of oxidizable gases is described in the following for purposes of simplicity. Reduceable gases behave in principle inversely, that is they increase also for example the sensor resistance, whereas in contrast oxidizable gases reduce the sensor resistance. The invention is sensibly applicable, even though inversely, also for reduceable gases.

FIG. 6 serves for illustrating the operational connections. The sensor in standard air delivers an actual sensor signal upon a heating power of 6b, characterized by 6a in FIG. 6, at the start. In the following the sensor is subjected to a gas impulse, wherein the time duration of the gas impulse is featured in FIG. 6 at the bottom.

The curve section 68 in FIG. 6 shows the course of the actual sensor signal in case of an uninfluenced heating power. In case of a non-influenced heating power the actual sensor signal returns to the starting value only after a longer time period after the end of the gas impulse. The section of the curve 68 following to the end of the gas impulse shows this reaction of the actual sensor signal to the gas impulse during constant heating power, wherein the constant heating power is illustrated in FIG. 6 by line 62.

The heating power with interference value switch on illustrated in FIG. 6 by the curve 63 in contrast leads to an actual sensor signal influenced by the heating power, wherein the actual sensor signal follows the curve section 64 shown in FIG. 6.

If the heating power is then always tracked (curve 63) for example proportional in the sense of a temperature increase, when the actual sensor signal passes through a change, then the actual sensor signal returns significantly quicker to the starting value. The section of the curve 64 following to the end of the gas impulse shows this reaction of the actual sensor signal onto the gas impulse in case of a tracked heating power, which is illustrated in a curve 63.

It is essential that in case of a gas concentrations actually present at the sensor, the reactions of the gas sensitive layer 33 occur at any rate with the gas. The temperature sensitivity of the sensor signal is decreased by the interaction with the gas. The change of the sensor signal caused by the temperature tracking is therefore smaller during the gas impulse as compared with prior to or after the gas impulse. In other words: the sensor signal reacts during the gas impulse only relatively weak to a change in the heating power and are thus interference value switch on. The gas induced reduction of the actual sensor signal assumes therefore approximately the same course upon tracking of the heating power as it is present in case of an otherwise identical test arrangement without temperature tracking. This means that the in each case falling branches of the curve 64 and 68 in FIG. 6 after the start of the gas impulse have an approximately equal course.

If however the reaction of the actual sensor signal is for example caused by a change of the air humidity or by a change of the air temperature, then the temperature sensitivity of the sensor signal does not change or changes only a little. A change of the air humidity or a change of the air temperature therefore exert substantial and continuing influence onto the actual sensor signal in case of a non-influenced heating power (curve section 65 in FIG. 6).

If however already at the start of such an interaction the heating power was tracking, then the influence of the sensor signal effected by the temperature tracking is substantially larger as in the case of a gas impulse. In other words: the sensor signal reacts heavily to a change in the heating power and thereby to the interference value switch on. Therefore the change of the sensor value caused by a change of the air humidity or by a change of the air temperature is not only much smaller, but also timewise clearly shorter (curve section 66 in FIG. 6) as is the case of a non-influenced heating power (curve section 65 in FIG. 6), and already the falling branches of the curves 65 and 66 in FIG. 6 have a not coinciding course.

Thus by way of the time behavior of the sensor signal it is possible to distinguish between a gas impulse and humidity impulse based on the invention method. The reaction of the sensor signal to humidity impulse is according to the present invention compensated to a such stencil parts by the heating tracking.

Therefore the automatic heating control of the sensor is constructed such according to the present invention that the temperature is the guide value of the heating automatic control or and that a perturbing value is switched onto the automatic control, wherein the perturbing value is derived from attenuation of the actual sensor signal from a standard value in case of standard air.

As was illustrated with reference to FIGS. 1 and 2, both the signal processing as well as the automatic heating control can advantageously be controlled by a single single-circuit controller (uC).

The advantageously result of a combination of

a. An arrangement of the sensor element 11 in a thermally insulated ore, respectively heat insulated casing 40 with a thermally insulating or, respectively, heat insulating diffusion layer 47, wherein a gas access to the sensor element 11 can be performed through the diffusion layer 47 by diffusion and without air motion,

b. A diffusion caused gas access to the sensor without air motion,

c. The heating of the sensor element 11 by automatic control of the temperature, wherein the relative deviation of the actual sensor resistance relative to the resistance of the sensor element 11 under standard conditions is switched on to the automatic control circuit as a perturbing value,

comprises that the sensor signal quickly and nearly exclusively follows and tracks the actual contents of oxidizable air content materials and exhibits substantially less drift appearances as are known at the present.

If an evaluation is performed which compares the actual sensor value with an average value obtained over the time period, then substantially smaller variations of the sensor signal under standard conditions can be assumed, in particular then, when the system built up a stable situation after some time.

According to a variation of an embodiment of the invention method therefore the time period through which the average value of the actual sensor signal is formed in order to serve as a comparison value to the actual sensor value, is not constant, but the time period increases again and again in the course of the operational time of the system.

The first comparison value is obtained out of the average value over a relatively short time period, since the system immediately upon switching on is subject necessarily to high self dynamic variations. This time period is increased after the switch on phase and the time period reaches finally in the built up state a substantially longer integration time. Since the average value in principle can coincide precisely with the actual sensor signal, a certain amount is deducted from the calculated average value in order to form the so-called reference value.

The amount to be deducted is very large in the initial phase according to a preferred embodiment such that the reference value shows a large distance to the sensor value. This is important in order to prevent that in the not built-up state signals are triggered even though no significant gas concentration change occurs. The amount is successively decreased in the further time course, such that the reference value approaches more and more to the sensor value in the built-up state.

Further refinements can be introduced. According to a further variation of an embodiment of the invention method the reference value is brought again to a larger distance relative to the sensor value after violent gas induced sensor reactions, because based on experience violent reactions of the sensor lead to temporarily instable sensor situations.

According to a further variation of an embodiment the calculation of the average value is performed again over shorter time periods, if a gas induced heavy signal change has occurred. According to a further embodiment the calculation of the average value is dispensed with for that time period during which a gas induced sensor signal change occurs.

Despite the recited steps the actual gas level can rise at such a slow speed that the average value essentially follows this rise. In this case slowly substantial gas concentration could form without that the precedingly described trigger condition would be fulfilled, according to which the actual sensor signal assumes a smaller value as compared to the reference value obtained by calculation.

According to a further variation of an embodiment in addition a minimum value is fixed for the reference value, wherein the actual reference value can never become smaller as compared with this fixed minimum value. The minimum value is selected such that this limit is not reached by sensor caused variations, but on the other hand the gas concentration, which gas concentration can be coordinated to this sensor signal, does not yet have a permanently damaging effect on the human being, or, respectively in case of a for example monitoring of explosion limits (for example methane air mixtures) this limit is disposed in the large safety distance relative to the explosion limits.

If the jump like changes of the humidity or of the temperature occur (for example in case of the application of the sensor at the suitable location in or at the breathing protective masks for purposes of filter or sealing monitoring), then the effect of these influence onto the sensor resistance will be absolutely small and only temporary upon employment of an invention method.

Nevertheless an erroneous signal triggering can occur, which then would be an undesired erroneous alarm.

According to a further variation of an embodiment therefore the time wise staggered evaluation is performed, which is illustrated with reference to FIG. 7.

A reference value 77 is disposed under the sensor standard level 71. If a gas impulse decreases the actual sensor signal by a certain amount (curve section designated with reference numeral 72), then the reference value is undershot and thereby the switching criterion is fulfilled. This triggers a kind of ‘quiet prealarm’, however the switching signal is not triggered according to the present invention. Only when the switching criterion remains fulfilled for certain time period illustrated in FIG. 7 by the time duration 73 then a switching signal is triggered, wherein the switching signal is maintained during the residual time period (designated with the time duration 74 in FIG. 7), during which time period the actual sensor signal remains lower as compared to the reference value.

If in contrast to very short time and therefore practically to be neglected gas impulse occurs or in case a humidity impulse to be compensated according to the invention occurs, which impulse triggers a reaction of the actual sensor signal as illustrated with reference numeral 75 in FIG. 7 then no switching signal is triggered according to the present invention.

According to a further variation of the invention method the time duration 73 of FIG. 7 of the prealarm is not fixedly defined but represents a function of the quickness of the sensor signal change or function of the absolute change amount relative to time.

If thus within a predetermined time period there occurs a very large sensor signal change, then the time period of the prealarm can be shortened. This is advantageous in order to be able to hold the time period up to the triggering of the alarm as short as possible in case of in fact suddenly occurring large gas concentrations.

Similar result can be accomplished when the sensor signal is average over two different time periods, for example both over time period of 20 seconds as well as over time period of 300 seconds. A certain amount of for example 2 percent of the standard value or the like is deducted from the average value formed over the longer time period as previously recited. The thus determined values are compared with each other.

If the average value formed over the shorter time period is smaller as the value resulting by averaging over the longer time duration and deduction of a certain amount (for example 2 percent), then a switching signal is triggered.

Mathematically this can be expressed by the formation of the following difference for example for the case, that the longer time duration is 10 times as long as the shorter time duration.

$$\frac{{S}_{1} + {S}_{2} + {S}_{3} + … + {S}_{n}}{n} - 0 , {98}^{*} \frac{{S}_{1} + {S}_{2} + {S}_{3} + … + {S}_{( {10}^{*} n )}}{{10}^{*} n} = Y$$

The switching criterion is reached when the value Y becomes negative.

However it is not sensible frequently to deduct only a constant value from the average value for forming a reference value, since the sensor characteristic curve (sensor signal depending on the gas concentration) is usually a nonlinear curve.

This means that for example 10 ppm (parts per million) of a certain gas depending on the basis resistance of the gas sensitive layer effects different resistance changes for the case that the ohmic resistance of the gas sensitive layer 33 is employed for forming the actual sensor signal. The relative resistance change caused by 10 ppm of a gas is substantially smaller for example by low basis resistance as compared to a high base resistance. This fact can be taken into consideration by taking into consideration the sensor characteristic curves of different object gases in the calculation of the reference value based on the obtained average value.

The use of the described sensor system is particularly critical, in case the system is taken in cooperation, while already a substantial gas load is present. Since the system namely cannot measure absolute concentrations, but only changes (referring to the reference value) within the observation time period, the system would not deliver any suggestion (switching signal, alarm) relative to the actual present load of gas.

This problem situation is resolved according to the present invention by short term increasing of the temperature of the gas sensitive layer. The temperature increase effects on the one hand the shifting of the reaction balance within the gas sensitive layer, which shows in a change of the sensor signal, and on the other hand the sensor is short term operated on the different (temperature dependent) characterizing curve. The capturing and the evaluation of the sensor signals prior to, during and after the short-term temperature increase enables conclusions relative to a possibly present gas load.

In the following various embodiments of a breathing protective mask according to the present invention are illustrated by way of FIGS. 8 through 12.

Different alternatively employable solutions are furnished according to the present invention for the gas technical connection of sensor and internal chamber of the mask.

1. As illustrated in FIGS. 8a and 8b, the sensor system 81 is gas sealingly attached at the mask a shoulder piece 80 integrated into the outer skin 82 of the mask.

The attachment is performed according to the present invention such that the sensor 83 is in connection with the eye chamber 84 of the mask. The eye chamber 84 is free from the exhaled breathing air of the carrier of the mask and contains only the part of the air which is inhaled based on the valve controlled air guidance 85, 86 in the mask. The attachment at the shoulder piece 80 advantageously is performed over a gas sealing screw winding or through a gas sealing bayonet closure 87 such that sensor system 81 can be easily and without special tool removed for the purpose of mask cleaning or in case of a non-use. Upon non-use of the sensor system the shoulder piece is gas sealingly closed with a blind plate for further employment of the breathing protective mask.

2. Breathing protective masks have available in most cases a viewing plate 91 (FIG. 9) made out of a clear transparent plastic, wherein the viewing plate 91 covers the larger part of the face. The viewing plate can be such modified that sensor system 81 can be attached at the viewing plate 91 in these cases without such essential interference of the field of view at the lower edge of the viewing plate. The sensor 83 is here gas technically connected to the eye chamber 84 of the mask through an outwardly directed gas sealing opening. The attachment of the sensor system (sensor plus electronic) is performed here again through gas sealing screw windings 95, gas sealing bayonet closures or other gas tight attachments disengageable easily without tool known to a person of ordinary skill in the art. The optical functioning and warning devices (for example light emitting diodes LED) 96 connected to the sensor system 81 can be reliably perceived since they are disposed immediately in the field of view. It is advantageous in connection with this variation that in case of a retrofitting of a present protective mask only the view plate has to be exchanged.

3. In cases where an attachment at the viewing plate or at the lower edge of the breathing protective mask is not possible or is not sensible, then the sensor system can also be carried staggered relative to the protective mask as illustrated in FIG. 10, for example at the closure belts of the breathing protective mask at the rear head or at the belt of the carrier of the device. The gas technical connection between the eye chamber 84 and sensor 83 is thereby advantageously performed for example through an outwardly gas tight flexible hose connection 102. The gas transferred from the eye chamber to the sensor can be performed by diffusion. This however it is associated with a disadvantage of a time delay between occurrence of a contaminant in the eye chamber and the detection by the sensor system which time delay can be under certain circumstances substantial. Therefore it is especially furnished according to the present invention that the gas transport between the eye chamber and the sensor is performed through an electrically operated small fan 103 or with the aid of a membrane pump, wherein the membrane pump is driven through the pressure differences occurring in connection with the normal breathing. Such a membrane pump driven by pressure differences can be defined easily by a person of ordinary skill in the art. The air transported to the sensor is either discharged to the outside air through a hinged valve 106 or is led back into the eye chamber through a further hose connection.

4. Alternatively the sensor system can also be attached to an adapter 112 disposed between the filter 113 and the mask (FIG. 11), however it is to be observed here that the hinged valve disposed usually between filter and mask within the connection thread in the mask is integrated on the filter side into the adapter 112. This is necessarily required because otherwise no leaks of the mask itself could be recognized. The gas transport from the eye chamber 84 to the sensor 83 based on diffusion is assured by this step without that other functions of the mask are interfered with.

The signaling of contaminants penetrating into the mask is performed optically according to the present invention, for example through light sources and preferably through different colored light emitting diodes LED. An alarm can alternatively or supplementary be performed also acoustically, for example with the aid of sound converters. For such deployment were the acoustic or optical capability of perception of the carrier of the device is limited then the employment of stimulant currents or irritant currents is suggested, wherein the stimulant currents or irritant currents are in fact medically harmless but nevertheless signalize reliably an alarm to the carrier of the device.

Since the sensor microsystem amongst others comprises an integrated microprocessor and other electronic components, it is conceivable that the system could be interfered by strong electromagnetic radiation or other disturbing influences such that an orderly functioning is not any longer assured. Therefore the essential parameters of the system for the functioning are monitored according to the present invention. In case of a purposeful functioning this is indicated by changing optical displays, for example preferably a blinking colored light emitting diode LED. The control of the optical display is performed here directly from the integrated microprocessor. This is associated with the advantage that based on the blinking of the display also the processor itself is monitored.

However there are also situations conceivable were an alarm signaling to the carrier of the mask device alone is insufficient. This is possible for example in case of suddenly occurring high contaminant concentrations in the breathing air, which rendered the carrier of the device incapable of acting. This situation can for example occur when the breathing protective mask is removed unintentionally from the face in a surrounding with high contaminant concentration. It is proposed according to the present invention for these cases that the data of the sensor microsystem (orderly function, gas concentration in the breathing air, alarm signal) are transmitted to a central office through a wireless remote data connection, for example a digitally coded radio connection. The signals of individual systems can also be differently digitally coded for distinguishing in case of a remote monitoring of several mask carriers with sensor system.

Frequently it is required possibly occurred contaminant loads of the carrier of the device to reconstruct afterwards, for example after work accidents. It is proposed according to the present invention for these or similar cases to store the relevant sensor data (for example proper functioning, gas concentration in the breathing air, alarm signal) in a digital storage during the operating time of the sensor system (comparable with the black box in commercial airliners). If required these data can be evaluated afterwards.

It is furnished according to the present invention for further variation of embodiment of the breathing protective mask with sensor microsystem to switch to a second filter in case of a presence of high contaminant concentrations in the breathing air of the carrier of the device. This however is only sensible, where the increased contaminant concentration is crossed by an exhausted filter. It is furnished according to the invention in case of the presence of increased contaminant concentrations to open automatically a valve which ventilates the interior of the mask with air or pure oxygen for additional safety even in such cases where a sudden untightness the of the mask occurs. The increased pressure drives thereby the loaded air to the outside and allows the carrier of the device to leave the loaded area or to perform other protective steps. The air or the pure oxygen is derived from a suitable pressure container, wherein the pressure container is attached on the outside at the mask.

It is additionally furnished as a safety increasing feature to furnish the mask with an additional sensor wherein the additional sensor monitors the air quality also outside of the mask. In case of a presence of predetermined contaminant concentrations in the outside air a so-called prealarm can be signaled, wherein the prealarm instigates the carrier of the mask to increased attention and care.

The sensor system preferably to be employed for the detection of contaminants penetrating into the mask is a microsystem comprising out of the components metal oxide sensor 122, electronic, microprocessor with integrated software 123 for controlling and evaluating of the sensor element (FIG. 12). The sensor is preferably mounted to a common carrier substrate, wherein the components for the analog/digital conversion, signal processing and heating control are disposed on the common carrier substrate.

1. Method for operating a sensor element for detection of gases or vapors contained in air, wherein the sensor element exhibits a gas sensitive layer and wherein the sensor element is electrically heatable by way of a heating structure, characterized in that the temperature of the sensor element (11) is automatically controlled and the temperature set point value is at least part-time changed by way of a perturbation value switch on depending on the size or the time behavior of the sensor signal.

2. Method according to claim 1 characterized in that the sensor signal is compared with reference value formed slidingly or adapted out of sensor signals of times past, wherein the difference between the sensor signal and the reference value and/or the time behavior of this difference is employed for triggering a switching signal.

3. Method according to claim 1 characterized in that the electrical resistance of the heating structure (32) furnished with a temperature coefficient is employed as an automatic control value for the temperature of the sensor element (11).

4. Method according to claim 1 characterized in that the temperature of the gas sensitive layer (33) is not maintained constant but a perturbing value switch on increasing the temperature of the gas sensitive layer (33) is performed depending on the time behavior of the sensor signal such that such perturbing influences, which are caused by changes of the physical surrounding conditions are distinguishable from such influences which are caused by a change of the gas composition or of the gas concentration based on the time behavior of the sensor signal.

5. Method according to claim 1 characterized in that the heating power is influenced for short time by the sensor signal by way of the perturbing value switch on that a change of the sensor signal, which is caused by a change of the air humidity or by a change of the air temperature is compensated quicker and/or to a larger extent as a change of the sensor signal which is caused by a change of the gas concentration.

6. Method according to claim 5 characterized in that a change of the sensor signal, which is caused by a change of the air humidity or at change in the air temperature is distinguishable from a change of the sensor signal which is caused by a change in the gas concentration by way of the in each case different time behavior of the sensor signal.

7. Method according to claim 5 or 6 characterized in that the distinction between change of the sensor signal, which is caused by a change in the air humidity or by a change of the air temperature and a change of the sensor signal, which is caused by a change of the gas concentration is performed automatically by way of suitable software.

8. Method according to claim 1 characterized in that an average value is formed out of sensor signals from times past and that the reference value suitable for triggering a switching signal is formed out of the average value for the at each time actual sensor signal, wherein the average value formation is suspended for the time period of the perturbing value switch on.

9. Method according to claim 8 characterized in that the characterizing curve of the sensor element is taken into consideration for formation of the reference value.

10. Method according to claim 8 characterized in that the average value formation is suspended and the old reference value is maintained for that time period during which the actual sensor value is smaller as the reference value formed out of the average value for detection of oxidizable air contents substances.

11. Method according to claim 8 characterized in that the average value formation is suspended and the old reference value is maintained for that time period during which the actual sensor value is smaller as the reference value formed out of the average value for detection of oxidizable air contents substances.

12. Method according to claim 8 characterized in that the time period of averaging taken into consideration for formation of the average value is variable.

13. Method according to claim 2 characterized in that the formation of the reference value is performed by taking into consideration sensor signals of times past, wherein the length of the time period taken into consideration is variable.

14. Method according to claim 2 characterized in that the formation of the reference value is performed by taking into consideration reference values of times past, wherein the length of the time period taking into consideration in this context is variable.

15. Method according to one of the claims 12 through 14 characterized in that the length of the time period taken into consideration depends on the time behavior of the sensor signal.

16. Method according to claim 1 characterized in that the sensor signal is averaged at the same time over two different time periods, wherein a certain amount is subtracted from the average value formed over the longer time period and that a switching signal is triggered, when the average value formed over the shorter time period becomes smaller than the value resulting from the averaging over the longer time period and subtraction of the certain amount.

17. Method according to claim 1 characterized in that the temperature of the heating structure is periodically temporarily increased and the sensor signals are compared prior to, during, and after each temperature increase for a qualitative determination of a presence of additional oxidizable or, respectively, reduceable air contents substances.

18. Method according to claim 1 characterized in that the change of the impedance of the gas sensitive layer (33) is employed for forming of sensor signal.

19. Method according to claim 1 characterized in that the change of the electrical resistance of the gas sensitive layer (33) is employed for formation of a sensor signal.

20. Method according to claim 2 characterized in that additionally a lower barrier is determined for the reference value, wherein the reference value can never undershoot the lower barrier and wherein the lower barrier cannot be reached by sensor caused variations, wherein the gas concentration which can be coordinated to this sensor signal does not inflict permanent damages to the human being or, respectively, is disposed in a far safety distance relative to the explosion barrier in case of for example a monitoring of explosion limits.

21. Sensor device for detection of gases or vapors contained in air by way of a sensor element, wherein the gas sensor element exhibits a gas sensitive layer and is electrically heatable by way of a heating structure, characterized in that The sensor element (11) is disposed in a casing (40), wherein the casing (40) shields the sensor element (11) from air motions occurring outside of the casing (40), wherein the casing (40) exhibits a diffusion layer (47), wherein a passage of gas and vapor from the outside into the interior of the casing (40) and vice versa is possible through the diffusion layer (47).

22. Sensor device according to claim 21 characterized in that the casing (40) and the diffusion layer (47) are formed heat insulating or thermally insulating.

23. Sensor device according to claim 21 characterized in that the diffusion layer (47) is formed out of a sinter material with a glass like or metallic structure.

24. Sensor device according to claim 21 characterized in that the diffusion layer is formed out of a gas permeable plastic foil.

25. Sensor device according to claim 21 characterized in that the sensor element (11) is a metal oxide sensor.

26. Sensor device according to claim 25 characterized in that the plastic foil comprises Teflon (PTFE).

27. Sensor device according to claim 21 characterized in that the sensor element (11) exhibits a heating structure (32) for the electrical heating of the sensor element.

28. Sensor device according to claim 27 characterized in that the heating structure (32) is a structured platinum layer.

29. Breathing protective mask with sensor microsystems easily removable for the purpose of mask cleaning wherein the sensor microsystem comprises a sensor, an electronic with microprocessor, and control/evaluation software characterized in that the microsystem informs the carrier or other persons about the contaminants penetrating into the breathing protective mask.

30. Breathing protective mask according to claim 29 characterized in that sensor system is attached on the outside at the outer skin (82) of the breathing protective mask and the gas sensitive sensor element (83) is gas technically in connection through an opening with the eye chamber (84) of the breathing protective mask.

31. Breathing protective mask according to claim 29 characterized in that the sensor system (81) is disposed outside of the breathing protective mask and is connected through a gas permeable connection such as for example a hose connection (102) to the eye chamber (84) of the breathing protective mask.

32. Breathing protective mask according to claim 31 characterized in that the gas transport is performed from the inner space of the breathing protective mask to the sensor system (81) through a pump actuated by the breathing.

33. Breathing protective mask according to claim 31 characterized in that the gas transport is performed from the inner space of the breathing protective mask to the sensor system (81) with the aid of an electrically operated pump or with a small fan (103).

34. Breathing protective mask according to claim 29 and at least one of the claims 30 through 34, characterized in that the proper functioning of the sensor system (81) is displayed optically or acoustically.

35. Breathing protective mask according to claim 29 and at least one of the claims 30 through 34, characterized in that contaminants penetrating into the breathing protective mask are signalized optically and/or acoustically.

36. Breathing protective mask according to claim 29 and at least one of the claims 30 through 35 characterized in that the contaminants penetrating into the breathing protective mask are signalized through a vibration alarm.

37. Breathing protective mask according to claim 29 and at least one of the claims 30 through 36 characterized in that the penetration of contaminants into the breathing protective mask is signalized to the carrier by an electrical stimulant.

38. Breathing protective mask according to claim 29 and at least one of the claims 30 through 37 characterized in that a non-properly functioning of the sensor system (81) and the contaminants penetrating into the breathing protective mask are messaged to a central office through a radio connection.

39. Breathing protective mask according to claim 38 characterized in that the breathing protective mask is digitally coded in case of a radio connection in order to allow the distinction of individual breathing protective masks such that the radio signals of the various breathing protective masks cannot be mixed up in the central office.

40. Breathing protective mask according to claim 29 and at least one of the claims 30 through 39 characterized in that the signals generated by the sensor system (81) are stored in an analog or digital memory storage for an additional later evaluation (black box).

41. Breathing protective mask according to claim 29 and at least one of the claims 30 through 40 characterized in that a switching to a second filter is performed upon penetration of contaminants into the breathing protective mask.

42. Breathing protective mask according to claim 29 and at least one of the claims 30 through 41 characterized in that upon penetration of contaminants into the breathing protective mask the breathing protective mask is ventilated from a container filled with compressed air or oxygen.

43. Breathing protective mask according to claim 29 and at least one of the claims 30 through 42 characterized in that the breathing of the carrier is the monitor with the aid of the sensor system (81) and an alarm signal is transmitted optically and/or acoustically and/or the coded radio connection upon changes of predetermined parameters (for example standstill of breathing).

44. Breathing protective mask according to claim 29 and at least one of the claims 30 through 43 characterized in that the breathing protective mask is furnished with an additional sensor system, wherein the additional sensor system monitors the quality of the outside air and delivers a prealarm upon reaching of a preset contaminants concentration, wherein the prealarm informs the carrier of the mask that the carrier is present in surroundings loaded with contaminants.

45. Breathing protective mask according to one of the claims 29 through 44 characterized in that the sensor element integrated into the microsystem is a heated metal oxide sensor, wherein the heated metal oxide sensor is disposed in isothermic casing and wherein the gas exchange is performed through a diffusion layer.

46. Breathing protective mask with a sensor microsystem easily removable for the purpose of mask cleaning and comprising electronics with microprocessor and control/evaluation software as well as a sensor device for the detection of gases or vapors contained in air with a sensor element, wherein the sensor element exhibits a gas sensitive layer and wherein the sensor element is electrically heatable by way of a heating structure, wherein the sensor element (11) is disposed in a casing (40), wherein the casing (40) shields the sensor element (11) from air motions occurring outside of the casing (40), wherein the casing (40) exhibits a diffusion layer (47), wherein a passage of gas and vapor from the outside into the interior of the casing (40) and vice versa is possible by diffusion through the diffusion layer (47), wherein the temperature of the sensor element (11) is automatically controlled and the set point value of the temperature is at least temporarily changed with an interference value switch on depending on the size and the time behavior of the sensor signal, wherein the microsystem informs the carrier and other persons about contaminants penetrating into the breathing protective mask.
